(19) United States
(12) Patent Application Publication
(10) Pub. No.: US 2003/0084067 A1
(43) Pub. Date: May 1, 2003

(54) Method and apparatus for asset management

(76) Inventor: Chudi Obiaya, Chicago, IL (US)

Correspondence Address: GREENBERG TRAURIG, P.C., 77 WEST WACKER DRIVE, CHICAGO, IL, 60601-1732, US

(21) Appl. No.: 10/283,651

(22) Filed: Oct. 30, 2002

Related U.S. Application Data
(60) Provisional application No. 60/340,431, filed on Oct. 30, 2001.

(51) Int. Cl. G06F 7/00

(52) U.S. Cl. 707/104.1

(57) ABSTRACT

A modular asset management tool is provided. The tool can be implemented on a computer system, which may include a web server. The tool can include multiple database modules which each store different types of asset information. The tool also includes multiple user interface modules, each user interface module having access to a predetermined set of database modules. A specific user interface module is selected when a user logs into the tool. The way in which information is presented to the user and the content of the information presented is determined by the selection of user interface modules. The user interface module may provide for dynamic report generation. Some user interface modules may be configured with limited access for implementation of a specific task, such as entry of work orders.

### This application claims the benefit of U.S. Provisional Application No. 60/340,431, filed on Oct. 30, 2001.

### BACKGROUND OF THE INVENTION

1. Field of the Invention

This invention relates in general to asset management. In particular, the invention relates to an improved system for tracking and displaying information relating to an organization's assets.

2. Background Art

As modern communication technologies redefine the speed at which information is conveyed and at which business is conducted, many corporations face increasingly competitive marketplaces. Accordingly, such businesses commonly turn to electronic and automated information systems to maximize the flexibility and efficiency of their organizations. One way in which businesses can streamline their operations and maximize the return on their asset investments is through active and skillful asset management.

Asset management typically involves the tracking of an organization's asset information to facilitate intelligent and efficient deployment of an organization's asset resources. Asset management is typically implemented using one of several computer software packages. Asset management allows an organization to identify a wide variety of asset information, including the type and quantity of assets controlled by the organization (including buildings, furniture, equipment and people); determine the location of each asset; identify the quality or state of each asset; track any maintenance requirements and/or utilization rates of each asset; and identify and monitor the operating cost metrics of each tracked asset.

Traditionally, business organizations utilize preconfigured, off-the-shelf asset management tools. As they grow and develop more complex asset tracking requirements, such businesses commonly commission the customization of these software tools, which then typically also require the reconfiguration of in-house computer servers to operate the systems as well as extensive employee training courses such that a reasonable number of employees are capable of operating the system.

However, many asset management tools face substantial practical limitations. One disadvantage of many asset management tools is a lack of flexibility and scalability. Users who grow into requirements for increased functionality face a substantial investment in generating customized tools capable of providing additional and customized asset tracking capabilities.

Furthermore, the value to an organization of many asset management tools is subject to limitations imposed by an inherent tradeoff between capability and accessibility. As the number and size of databases maintained by the tool to track various types of assets is increased, and the richness of the tool feature set expands, the capabilities of the tool are greatly expanded. However, simultaneously the operation of typical tools also becomes increasingly complex. Thus, with the increased capability comes increased training and knowledge required to utilize that capability.

While an organization may train a dedicated asset manager to operate complex and highly capable asset management tools, the value of the tool is often constrained by limitations on the accessibility of the information it contains. When the tools are highly complex, executives and other key decision-makers are typically limited in their ability to directly or readily access critical information. Even worse, oftentimes information will not be available quickly enough, or in a sufficiently understandable form, to be utilized in a time-sensitive decision-making process. Thus, the full potential of the asset management tool is not realized.

Accordingly, it would be desirable to provide an asset management tool featuring seamless scalability to adapt as the complexity of an organization's asset management requirements evolves. Furthermore, it would be desirable to implement an asset management tool with a complex feature set that can still be readily accessed and utilized for specific purposes by untrained or minimally trained individuals.

### SUMMARY OF THE INVENTION

An asset management tool is presented which provides multiple user interface modules enabled with access to one or more databases from a common set of asset database modules. The database modules each process a particular type of asset information, and the number and type of modules implemented within the database module tier can be dynamically configured to provide scalability. The user interface modules are each tailored to a particular set of user needs, such as for a facilities manager or a corporate executive. Each interface module can provide a differing level of access to the information stored within the databases. The tool can thus directly integrate asset management information from multiple departments and multiple types of users into a common set of databases while configuring the information to suit the particular needs of each user.

A user interface module can optionally be configured with access to less than all of the available database modules, as may be desirable for certain types of users. For example, a work order request user interface module can be provided through which general users can enter work order requests directly into a project database module. By providing a simplified user interface with a limited feature set and access restricted to particular database modules, general users can be provided with direct access to the asset management tool without undergoing substantial training and while still maintaining security over other information stored within the tool.

The user interface modules may provide for dynamic report generation utilizing information retrieved from associated database modules. The reports can be generated using variable parameters. As a user changes parameters, the report can be automatically regenerated according to the revised parameter set, thereby providing specifically-targeted reporting of asset utilization and other data.

The tool can also be readily implemented by an application service provider for the provision of asset management services to outside organizations. Access to the application or a particular set of data within the database module tier can be provided based upon information entered by the user that is received by log-in module 100. The information entered is matched against the pre-authorized user data in the database to ascertain the user identity and level of access to be provided. The fee charged to an outside organization by service providers may be based upon the number of pre-authorized users, number of organization sites and/or the number of database modules to which the organization's users are provided with access.

### BRIEF DESCRIPTION OF THE DRAWINGS

FIG. 1 is a functional block diagram of an asset management tool according to one embodiment of the invention.

FIG. 2 is an illustration of a log-in module interface screen.

FIG. 3 is an illustration of an interface provided by a facility management user interface module.

FIG. 4 is an illustration of an interface provided by an executive summary interface module.

FIG. 5 is an illustration of a site list screen.

FIG. 6 is an illustration of a site detail screen.

FIG. 7 is an illustration of a building list screen.

FIG. 8 is an illustration of a building detail screen.

FIG. 9 is an illustration of a building financial screen.

FIG. 10 is an illustration of a space list screen.

FIG. 11 is an illustration of a space detail screen.

FIG. 12 is an illustration of a space financial screen.

FIG. 13 is an illustration of a project list screen.

FIG. 14 is an illustration of a project detail screen.

FIG. 15 is an illustration of a project team screen.

FIG. 16 is an illustration of a project request screen provided by a work order request module.

FIG. 17 is an illustration of a dynamic report selection screen.

FIG. 18 is an illustration of a dynamic report screen.

FIG. 19 is an illustration of a dynamic report graph.

FIG. 20 is a diagram of a technical architecture that can be utilized by an application service provider to implement an asset management tool.

### DETAILED DESCRIPTION OF THE DRAWINGS

While this invention is susceptible to embodiment in many different forms, there are shown in the drawings and will be described in detail herein several specific embodiments. The present disclosure is to be considered as an exemplification of the principle of the invention intended merely to explain and illustrate the invention, and is not intended to limit the invention in any way to embodiments illustrated.

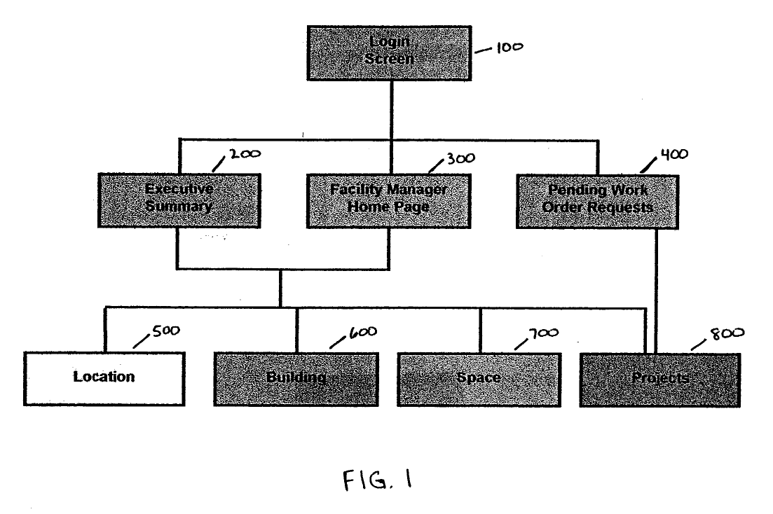

FIG. 1 illustrates a block diagram of a modular asset management tool according to an embodiment of the invention. The illustrated tool identifies the type and quantity of an organization's assets, including buildings, furniture, equipment and people; determines the location of each asset; identifies the quality or state of each asset; tracks the maintenance needs and utilization rates of assets; and identifies and monitors the operating cost metrics of tracked assets.

The tool features a plurality of user interface modules 200, 300 and 400. Login module 100 directs users to an appropriate interface module. Each user interface module is enabled with access to one or more of a plurality of common database modules 500, 600, 700 and 800. In accordance with one aspect of the tool, scalability can be provided through the reconfigurability of the database modules with which the user interface modules exchange information. For example, a small organization may begin using the tool with only location module 500 and building module 600 within the database tier. As the organization desires to increase the functionality and capabilities of the asset management tool, additional database modules can be added to the system, such as space module 700 and project module 800.

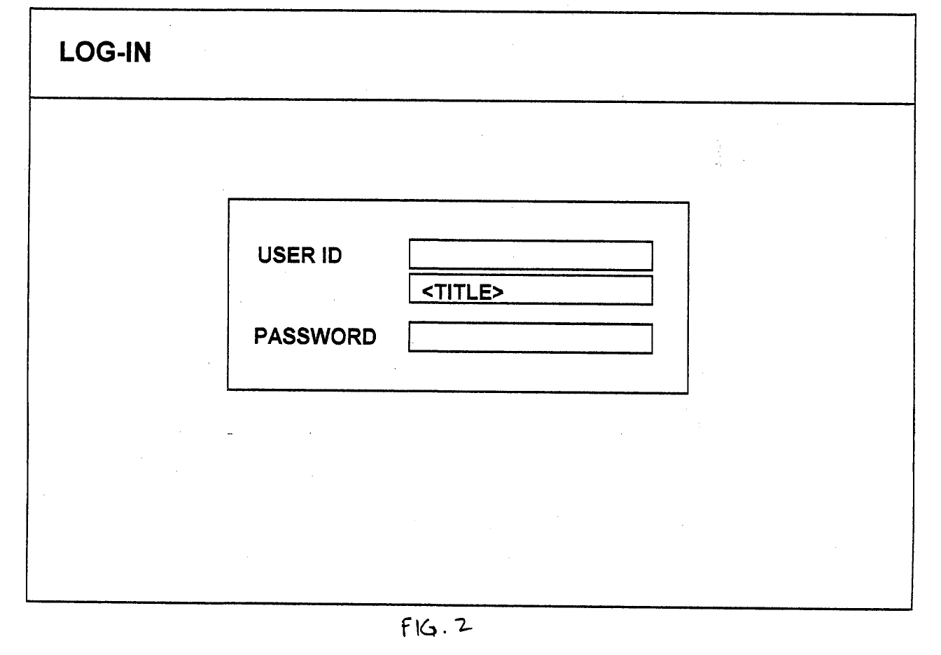

FIG. 2 is a screenshot of one embodiment of log-in module 100. The module prompts the user for entry of a user ID and password. Module 100 authenticates the user and, upon successful authentication, passes operation of the tool to one of user interface modules 200, 300 or 400. The selection of the user interface module to which operation of the tool passes is determined by the user ID received by module 100. For example, if the user ID received by module 100 is that of a corporate vice president, operation of the tool may pass to executive summary module 200. If the user ID entered into module 100 is that of an asset management professional, operation of the tool may pass to Facility Manager Home Page 300. If the user ID entered into module 100 is that of a building tenant seeking to generate a work order, operation of the tool may pass to Work Order module 400.

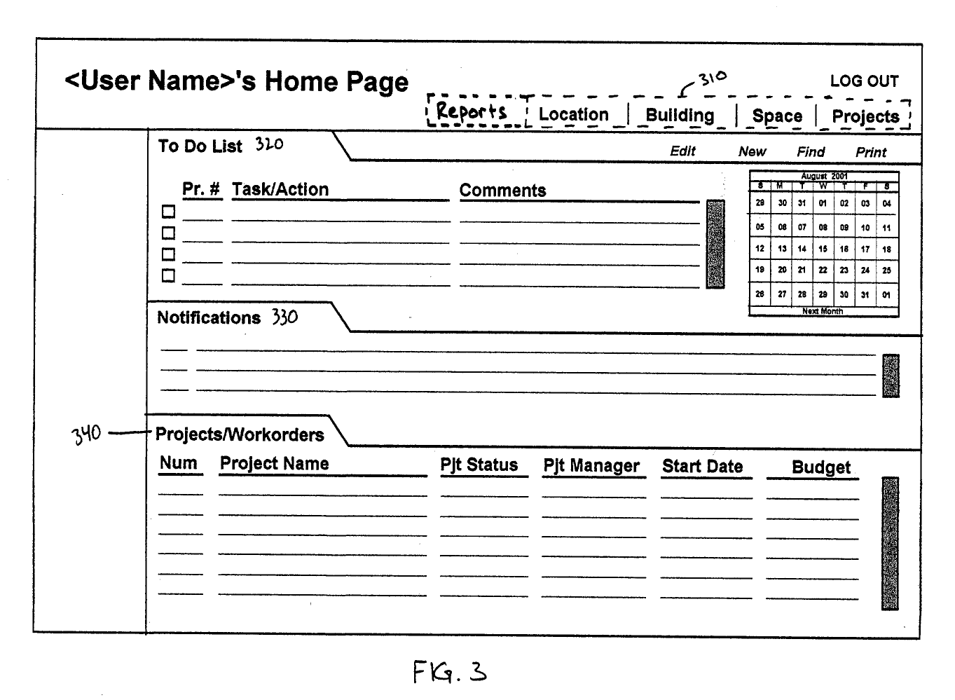

FIG. 3 illustrates a home page screen shot presented by facility manager interface module 300. In the illustrated embodiment, related data is categorized and displayed within groups on each screen generated by the interface modules, in intuitive layouts simulating folders within a file drawer. The user interface modules further generate displays specifically configured to match a user's preferences and predefined information requirements.

Facility manager interface module 300 initially displays an information summary comprising several data groups, including “To Do” task list 320, list of urgent Notifications 330 and list of pending Projects or Work Orders 340. Interface region 310 provides one-touch access to a plurality of interface screens configured for interaction with location database 500, building database 600, space database 700 and project database 800. Information presented by module 300 may be retrieved from one or more database modules in the database system tier. For example, Project/Workorder list 340 displays information retrieved from projects database module 800.

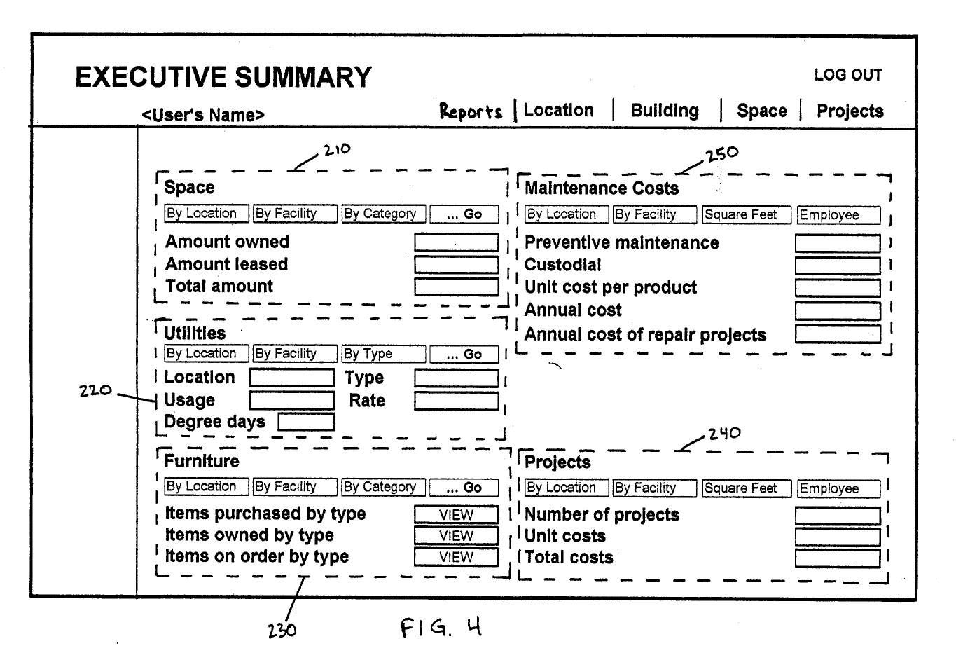

FIG. 4 illustrates a screen shot presented by executive summary interface module 200. As with facility manager interface module 300, executive summary interface module 200 can present information drawn from one or more of the databases from the system database tier. For example, space summary region 210 displays information drawn from space module 700. Furniture summary region 230 displays different information drawn from space module 700. Project summary region 240 includes information drawn from project database module 800. However, in contrast to project display 340 provided by facility manager interface module 300, region 240 displays the project information in a differing format appropriate for the intended user of interface module 200. Rather than displaying detailed information regarding the specific projects pending in module 800, region 240 displays summary information that may be more useful to a corporate executive. Moreover, the summary information is displayed without requiring the user of interface module 200 to navigate complex, feature-rich menus or to configure and run reports. Thus, by providing a separate user interface module for users with differing needs, the value of the information contained within the asset management tool can be unlocked for untrained users without limiting the feature-set available to trained or experiences users of the tool.

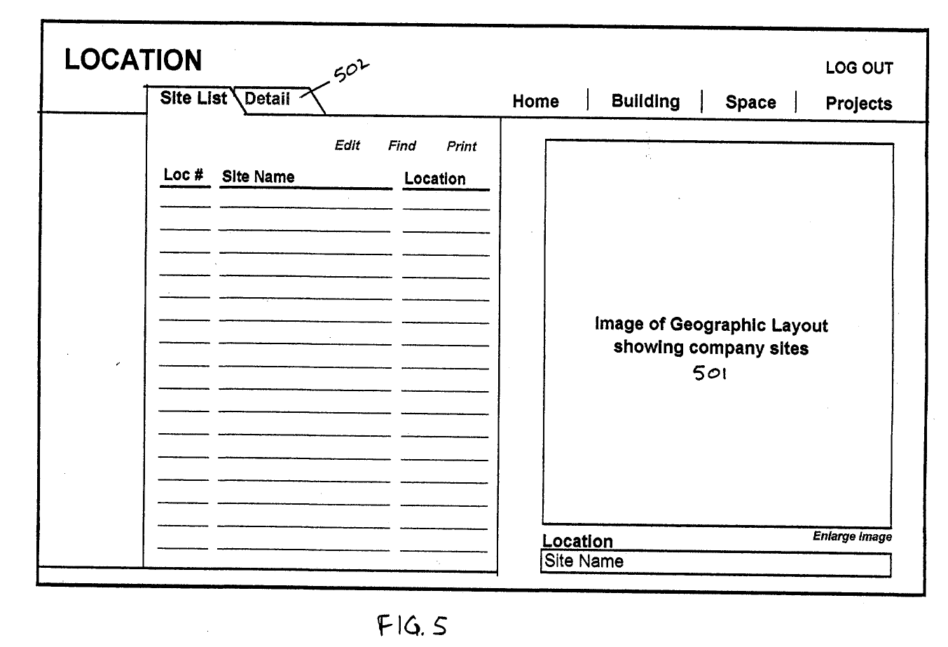

FIG. 5 is a screenshot of the location site list interface that can be generated by a user interface module upon selection of the Location option, such as that within interface region 310 of FIG. 3. The site list page provides for a listing of property locations owned and/or managed by the users of the asset management tool. A text-based listing of sites is provided within the lefthand region of the interface, while a graphic image is depicted in righthand region 502. The graphic image in region 502 may be an overall map depicting the location of each site within the text-based listing. Optionally, when a site is selected from the list on the lefthand region interface, a graphic image depicting the selected site is displayed in righthand portion 501 of the interface. Types of images that can be displayed include a photographic image of the selected site, a map or a schematic drawing of the site layout.

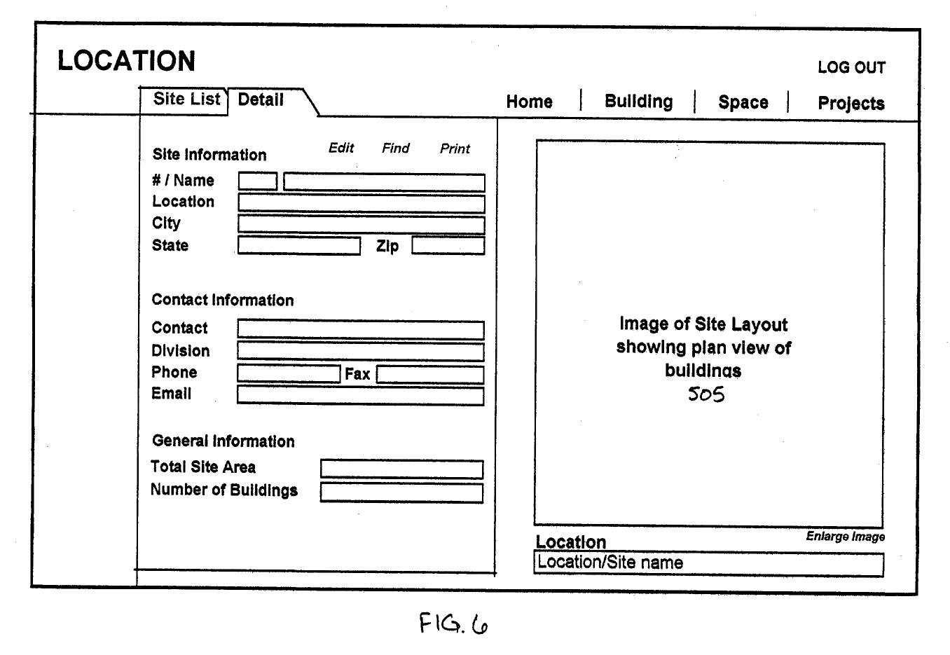

The location interface also includes detail tab 502. The interface of detail tab 502 is shown in FIG. 6. The detail tab provides specific information concerning the particular site selected within the site listing of FIG. 5. The detail tab also provides image region 505, which can display an image such as a site layout map showing a plan view of buildings at the selected site. By providing a separate detail tab automatically linked to the selection on an overall site list, greater levels of information are readily available to the user without creating a display screen that is initially confusing or overwhelming in its information density.

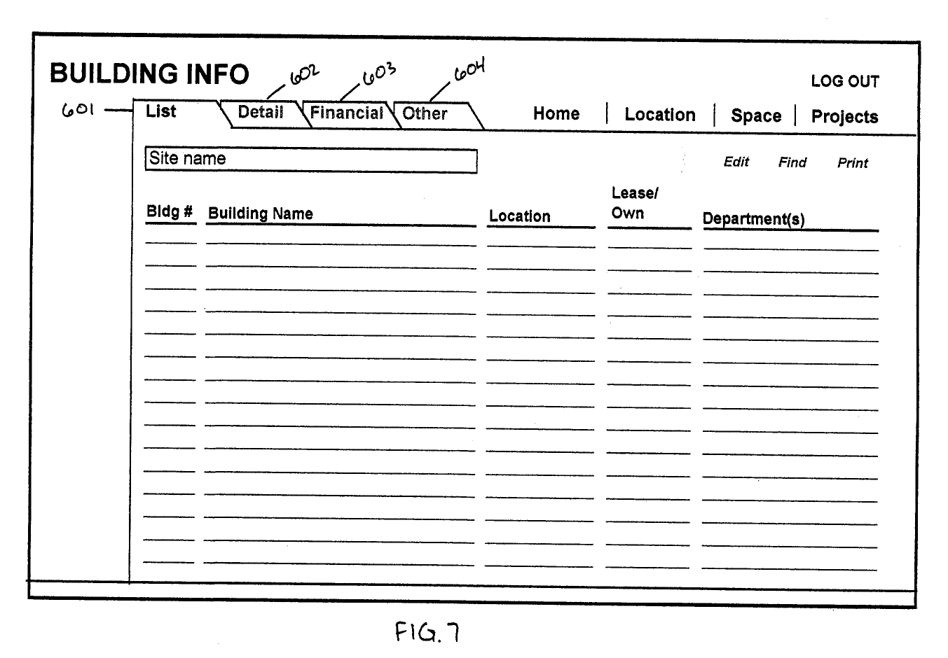

FIG. 7 is a screenshot of list tab 601 of the building information interface that can be presented upon selection of the Building option within interface region 310 of FIG. 3. The building information interface includes a list of each building managed, and some basic information about each building. The building information interface also includes detail tab 602, financial tab 603 and other tab 604. Again, tabs 602, 603 and 604 enable ready and intuitive access to detailed information while maintaining a reasonable level of information density suited to the particular user for whose use the interface module is intended.

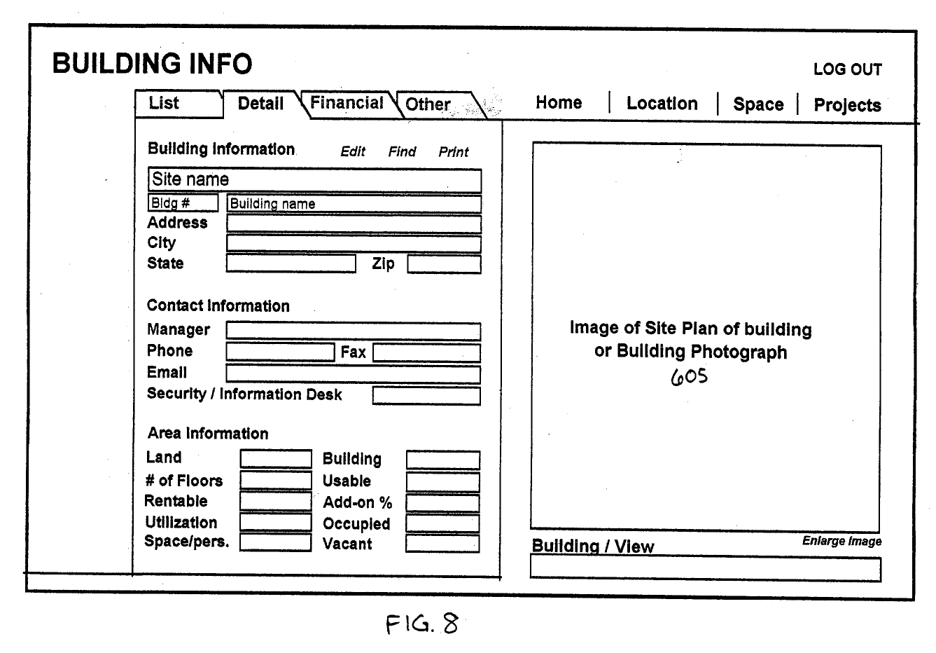

The interface of building detail tab 602 is illustrated in FIG. 8. Detailed information is presented relating to a specific building selected from the building list provided by list tab 601. Additionally, a graphic image relating to the selected building is displayed in interface region 605. Such an image may include a site plan view or a photograph of the selected building.

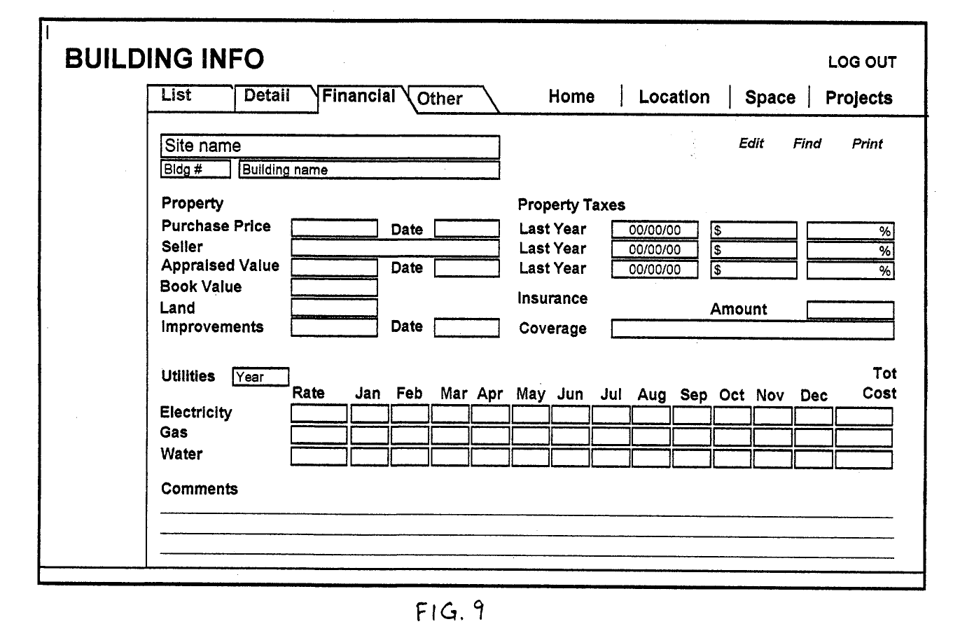

The interface of building financial tab 603 is illustrated in FIG. 9. Financial tab 603 presents financial information relating to the operation of the building selected from the building list provided by list tab 601. Such information may include property purchase price, property taxes, and utility costs.

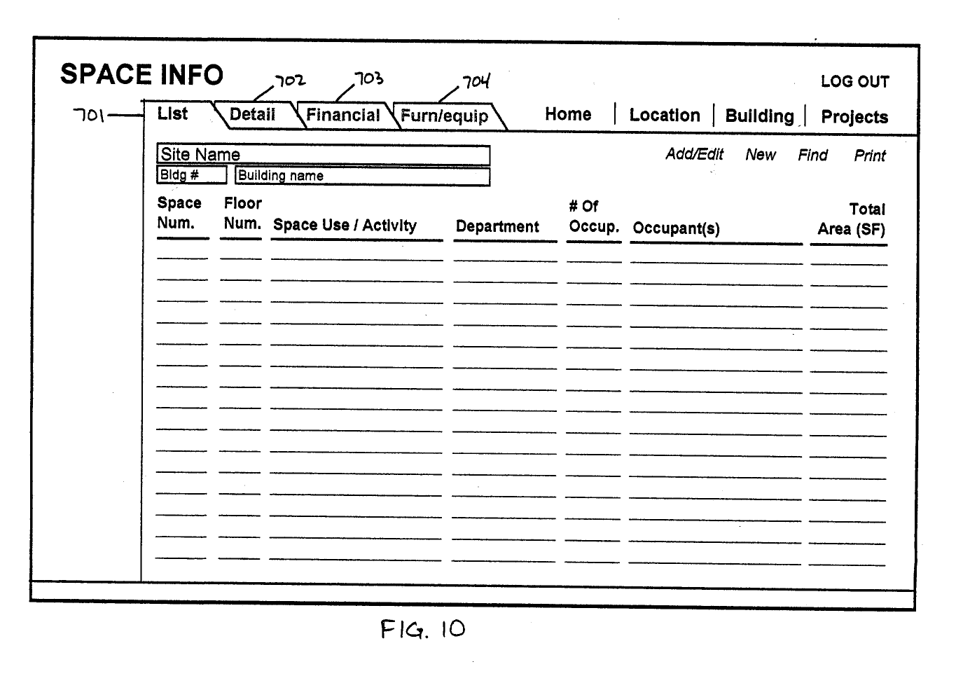

FIG. 10 is a screenshot of the space list interface that can be generated by user interface modules upon selection of the Space option, such as that within interface region 310 of FIG. 3. The space interface provides information relating to the use of physical space within a building. Space list tab 701 provides a text-based listing of each space allocation, and basic information describing each space allocation.

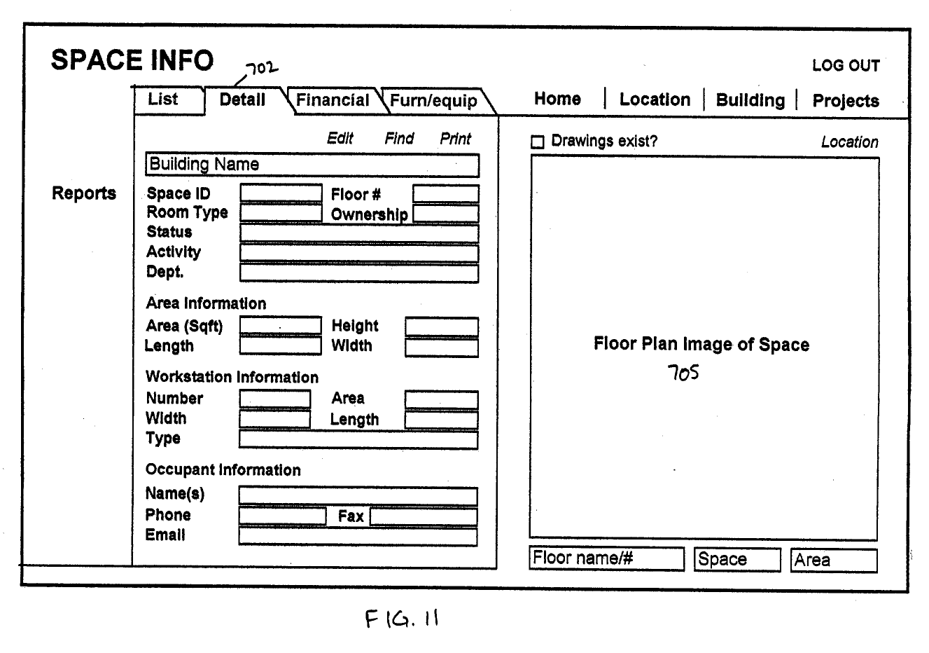

The interface of space detail tab 702 is illustrated in FIG. 11. Detailed information is presented relating to a specific space allocation selected from the space list provided by list tab 701. Such information may include the location of the space allocation, the size of the allocated space, and the user or occupants of the space. Additionally, a graphic image relating to the selected space allocation, such as a floor plan image of the space, is displayed in interface region 705.

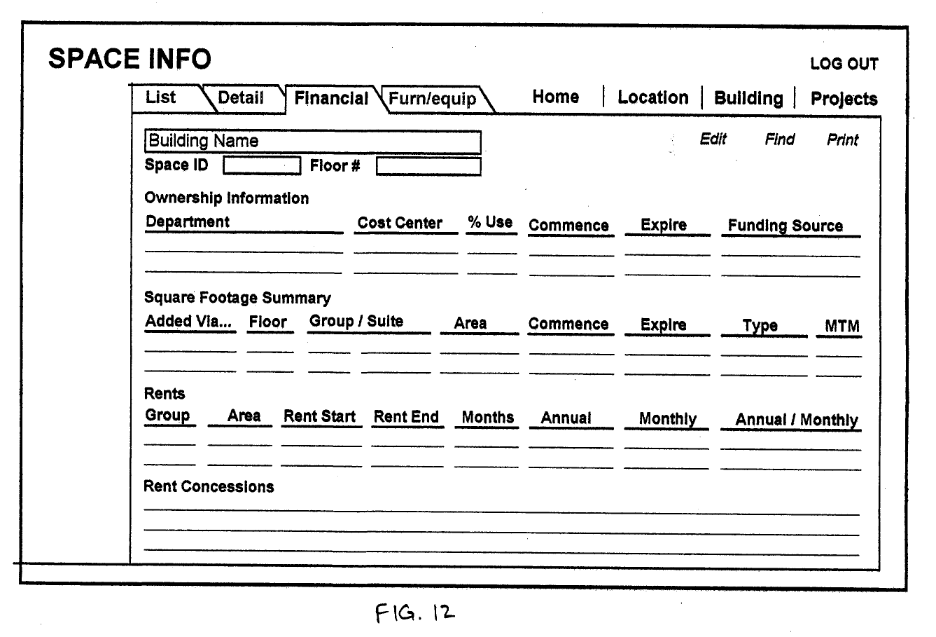

The interface of space financial tab 703 is illustrated in FIG. 12. Financial tab 703 presents financial information relating to the space allocation selected from the space allocation list provided by list tab 701. Such information may include space allocation ownership information, cost information identifying the expense involved in owning and/or maintaining the space as well as the organization to which the space expenses should be allocated.

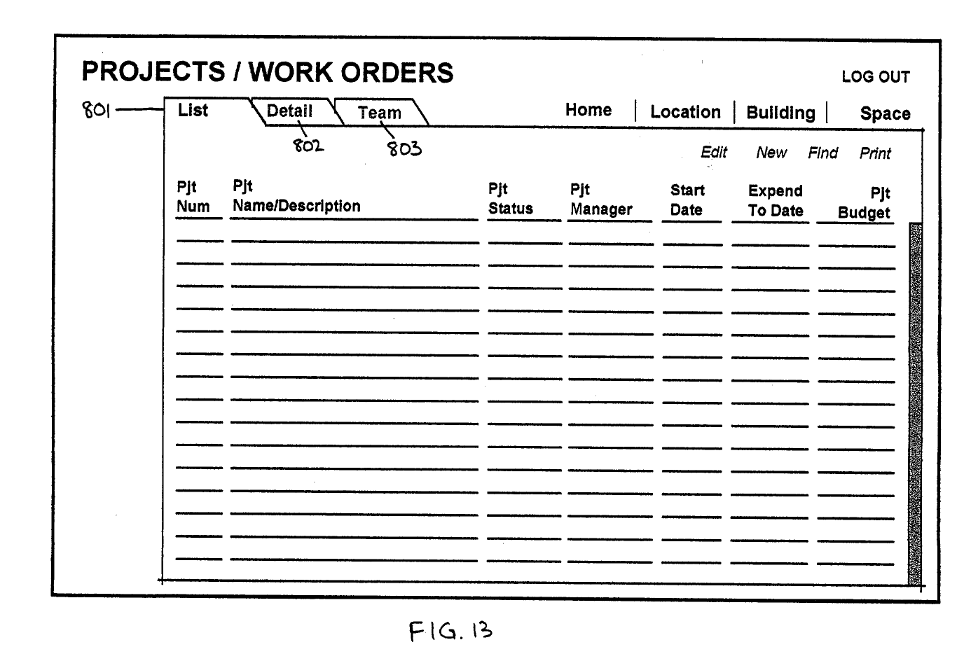

FIG. 13 is a screenshot of the project list interface that can be presented upon selection of the Projects option, such as that provided within interface region 310 of FIG. 3. The project interface provides information relating to projects or work orders that have been identified for completion, such as maintenance projects like the changing of a light bulb or the reconfiguration of cubicle space. Project list tab 801 provides a text-based listing of each pending project, and basic information describing the nature of the project. The illustrated project interface also includes detail tab 802 and team tab 803.

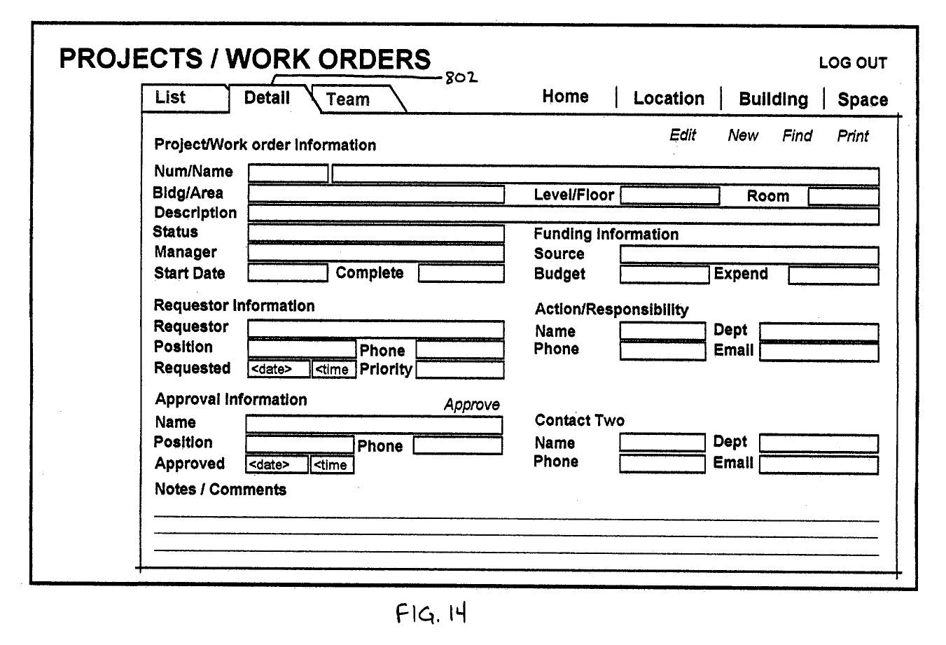

The interface of project detail tab 802 is illustrated in FIG. 14. Detailed information is presented relating to a specific project selected from the project list provided by list tab 801. Such information may include the location at which the project is to be performed, cost information relating to the project, the identity of the individual requesting the project, and information relating to the project approval.

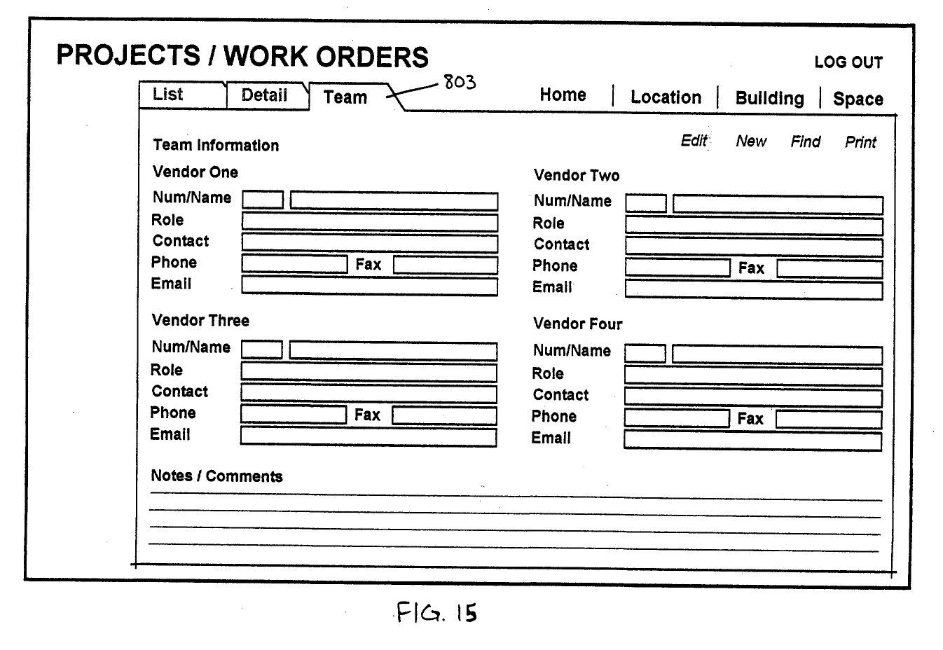

The interface of team tab 803 is illustrated in FIG. 15. Team tab 803 displays detailed information concerning the individuals or entities involved in performance of the particular project selected from the project list of list tab 801. For example, a project for work space reconfiguration may involve a cubicle equipment vendor for supplying cubicle walls, cabinets and desktops, an electrical contractor for wiring power, telephone and computer network connections within the workspace, and a general maintenance professional for general assembly of the workspace and relocation of furniture.

While executive summary interface module 200 and facility manager interface module 300 are each enabled with access to all provided database modules 500, 600, 700 and 800, it may be desirable to configure user interface modules for purposes which require interaction with less than the full range of database modules implemented by the asset management tool. For example, work order request interface module 400 is provided to allow general users to submit requests for maintenance or other work orders directly into the asset management tool. Accordingly, interface module 400 is provided with access only to project database module 800. By providing a user interface module having interaction limited to a particular database module, access can be provided to general users such as all corporate employees, or all tenants of a large office building, without comprising the security or integrity of data in the remaining database modules.

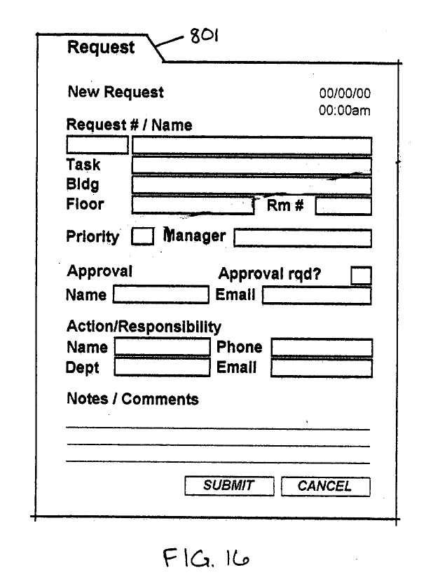

A screenshot of the interface provided by module 400 is illustrated in FIG. 16. The interface can be provided to a standard internet web browser running on a client-side personal computer. Request tab 801 provides for the entry of information describing a work order request. The information describing the request can then be conveyed directly to project database module 800. The request is then promptly integrated into the data presented to users of other interface modules such as interface modules 200 and 300. In this way, work order requests such as replacement of a light bulb, can be submitted directly into the asset management tool. Information relating to the work order can then be distributed and approvals obtained in an automated fashion, with appropriate information conveyed to various types of users of the asset management tool. For example, facility manager interface module 300 may be configured to display and allow the editing of all data relating to each work order. Facility manager interface module 300 may further require approval of each work request before the work request is displayed by a user interface module used by a maintenance worker. Executive interface module 200 may be configured to provide only for the display of summary work order cost information.

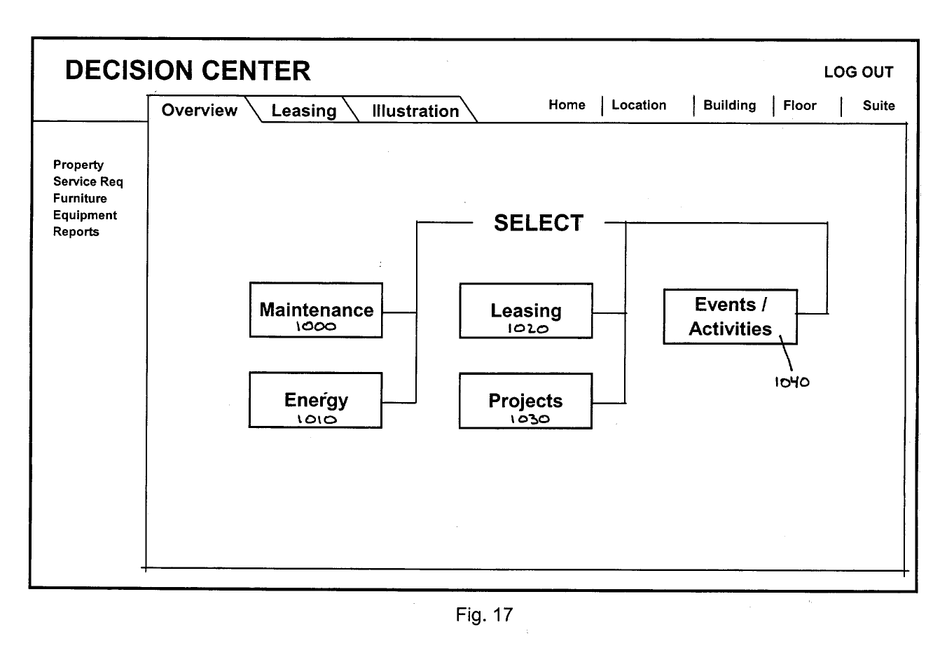

The illustrated asset management tool also provides for the generation of dynamic reports. Dynamic reports access database modules for purposes of implementing calculations which can be defined by the end user. Thus, the parameters of reports can be dynamically configured to suit a particular desired inquiry. In the illustrated embodiment, the report feature can be accessed via selection of the REPORTS option in, for example, region 310 of FIG. 3. FIG. 17 illustrates a starting page for generation of a dynamic report. Available dynamic reports are divided into several categories, which can be chosen via selection of MAINTENANCE button 1000, ENERGY button 1010, LEASING button 1020, PROJECTS button 1030 or EVENT/ACTIVITIES button 1040.

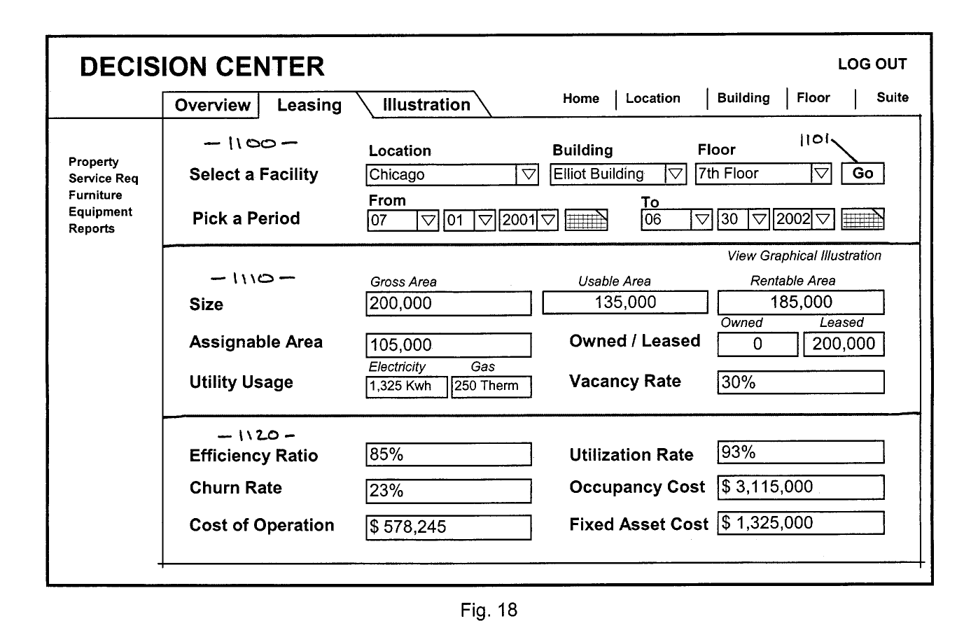

FIG. 18 illustrates a dynamic report corresponding to selection of LEASING button 1020 in FIG. 17. Report configuration region 1100 includes numerous pulldown menus which allow for dynamic selection of a desired facility and time period over which report calculations are to be run. The report that has been dynamically configured can then be immediately generated by selection of button 1101. While the illustrated embodiment provides certain parameters which are available for configuration by the end user, it is understood that additional or differing parameters can also readily be provided for end user configuration. Upon configuration and execution of the dynamic report, data is recalled from database modules such as modules 500, 600, 700 and 800, and calculations are performed in accordance with the selected parameters. Resulting calculations are displayed in results areas 1110 and 1120. Upon consideration of the information presented in results areas 1110 and 1120, the user can then readily reconfigure the report parameters to compile further information.

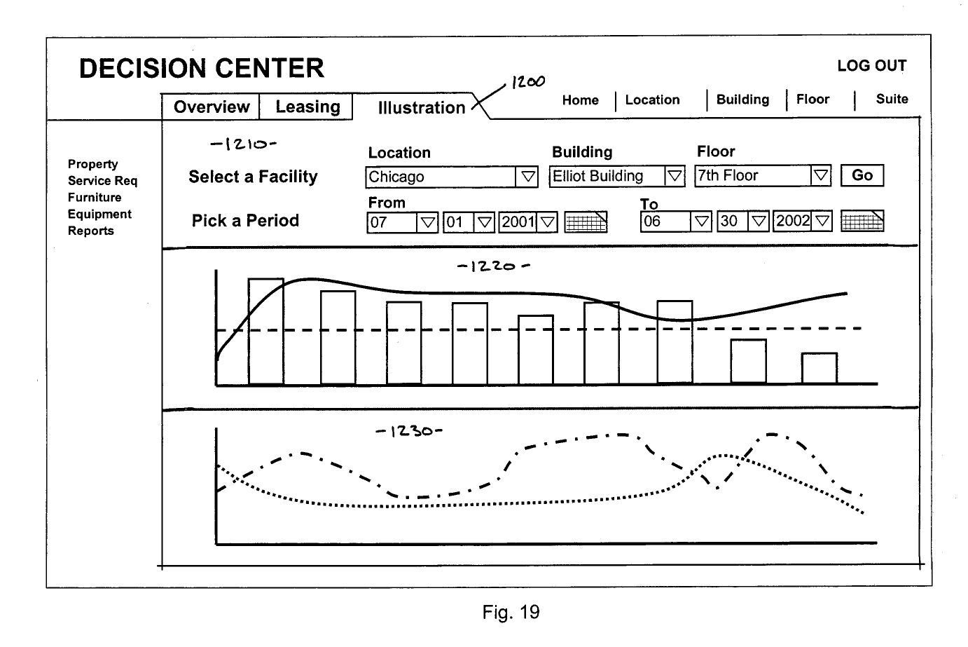

The dynamic report feature can also be utilized to provide graphical illustration of data maintained by the asset management tool, via selection of Illustration tab 1200 (FIG. 19). Dynamic report parameter region 1210 identifies the current report parameters, and provides for dynamic reconfiguration of those parameters by the user through use of pulldown menus analogous to those of region 1100. Report results regions 1220 and 1230 provide graphical illustration of the data corresponding to the selected report parameters.

The asset management tool illustrated in FIGS. 1 through 19 is particularly suitable for the implementation by an application service provider in providing asset management services to outside organizations. In such an application, the service provider can maintain the database tier, and provide user interface modules appropriate for each client's users.

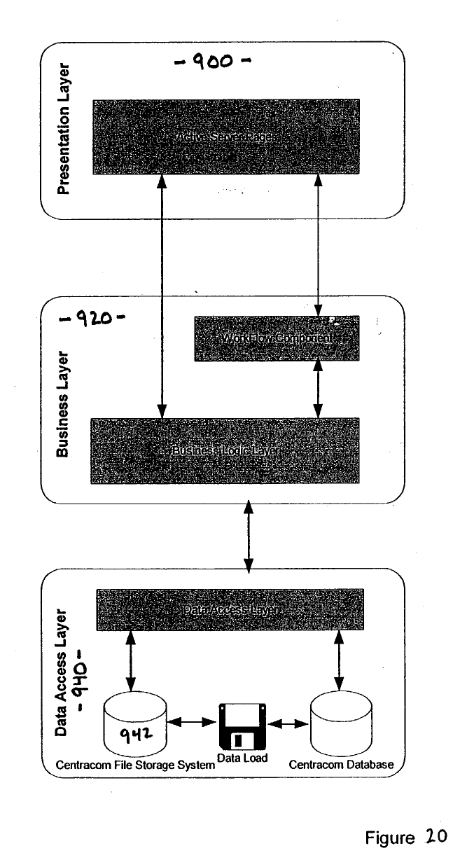

FIG. 20 illustrates a technical architecture that can be utilized by an application service provider to implement the asset management tool. The technical architecture of FIG. 20 includes three layers: presentation layer 900, business layer 920 and data access layer 940. Presentation layer 900 is implemented using a standardized Internet web server, accessible from client locations using a standard web browser for presentation of the asset management tool to the user.

Presentation layer 900 receives the information that is served to client-side users from business layer 920. Business layer 920 provides for implementation of login module 100 and user interface modules 200, 300 and 400. In so doing, it retrieves and formats data in accordance with the user's actions and the parameters associated with the user interface module that is being implemented. In order to free up threads in the web server of presentation layer 900, it may be desirable to implement a workflow component within business layer 920 to queue transactions with no feedback requirements.

In order to maintain the flexibility of information layout and to maintain separation of asset data from its encapsulating presentation formatting, business layer 920 may assemble user information in XML. However, to ensure compatibility with the widest variety of client-side web browsers, it may be desirable for presentation layer 900 to serve web pages using HTML. In such an implementation, presentation layer 900 may transform XML documents into HTML prior to their serving.

Business layer 920 retrieves data from data access layer 940. Data access layer 940 implements database modules 500, 600, 700 and 800. Data access layer 940 may be comprised of a standard database package, such as SQL Server 2000. Data access layer 940 further includes a RAID array file storage subsystem 942 for storage of resources such as architectural drawings, site drawings, maps and other graphic files.

The foregoing description and drawings merely explain and illustrate the invention and the invention is not limited thereto except insofar as the appended claims are so limited, inasmuch as those skilled in the art, having the present disclosure before them will be able to make modifications and variations therein without departing from the scope of the invention.

I claim:

1. An asset management tool implemented on a computer system, the tool comprising:
a plurality of database modules, each of which stores information relating to at least one predetermined type of asset;
a plurality of user interface modules, including at least a first user interface module capable of exchanging data with a first predetermined set of at least one of the plurality of database modules, the first interface module being configured to generate digital documents containing asset data retrieved from one or more of the first predetermined set of database modules, which digital documents are configured in accordance with a first predetermined layout format and conveyed to a web browser for display; and
a second user interface module capable of exchanging data with a second predetermined set of at least one of the plurality of database modules, the second interface module being configured to generate digital documents containing asset data retrieved from one or more of the second predetermined set of database modules, which digital documents are configured in accordance with a second predetermined layout format and conveyed to a web browser for display.

2. The asset management tool of claim 1, where the first predetermined set of database modules differs from the second predetermined set of database modules.

3. The asset management tool of claim 1, the tool further comprising
a login module which receives information uniquely identifying an individual using the asset management tool, and selects one of the plurality of user interface modules to generate digital documents provided to the individual based upon the information received by the login module.

4. The asset management tool of claim 1, the asset management tool further comprising a work order request digital document generated by the first user interface module which, when displayed by a web browser, provides for entry of maintenance task information describing a maintenance task to be performed on an asset managed by the asset management tool into a work order database module comprised of one of the plurality of database modules.

5. The asset management tool of claim 4, in which the first predetermined set of database modules contains exactly one database module, whereby the first user interface module is provided with database access only to the work order database module.

6. The asset management tool of claim 4, the asset management tool further comprising a work order summary digital document generated by the second user interface module which contains information retrieved from the work order database module.

7. The asset management tool of claim 1, in which the second user interface module is further comprised of a dynamic report generation module, the dynamic report generation module generating at least
a first digital document which, when displayed by a web browser, provides for entry of report parameters describing the contents of a desired report; and
a second digital document which, when displayed by a web browser, displays information derived from the report parameters and data retrieved from at least one of the plurality of database modules.

8. The asset management tool of claim 1, in which the computer system is comprised of:
a data access layer comprising a database and a file storage system, the data access layer implementing the plurality of database modules;
a business logic layer linked to the data access layer and implementing the plurality of user interface modules;
a presentation layer comprising a web server linked to the business logic layer, the presentation layer conveying information to a web browser operated by a user of the asset management tool via a computer network.

9. A method for providing an asset management tool comprising:
providing a web site hosted by at least one computer in communication with a computer network;
providing a database containing asset information associated with predetermined assets managed by the asset management tool, the database being accessible to the web site;
logging in to the web site by a first user using a web browser by providing login information associated with the first user;
selecting a first user interface from amongst a plurality of different user interfaces based upon the login information associated with the first user;
displaying information retrieved from the database by the web browser, where the content, layout and accessibility of the asset information is determined at least in part by the first user interface.

10. The method of claim 9, in which the step of providing a database is further comprised of the step of providing a plurality of database modules, each module containing information associated with a different type of asset, the accessibility of each database module to the first user depending upon the result of the step of selecting a first user interface.

11. The method of claim 9, which method further comprises the steps of:
providing a first web page providing for the configuration of a plurality of parameters associated with the generation of an asset information report;
providing a second web page containing a report of asset information, the contents of the second web page being derived from the plurality of parameters and from asset information retrieved from the database.

12. The method of claim 9, where
the step of selecting a first user interface from amongst a plurality of different user interfaces based upon the login information is further comprised of selecting a work order user interface;
the method further comprising the steps of:
displaying a document by the first user interface which provides for the entry of information describing a work order request;
entering information by the first user via the web browser describing the work order request;
storing the information describing the work order request in the database.

13. The method of claim 12, the method further comprising the steps of:
logging in to the web site by a second user using a web browser by providing login information associated with the second user;
selecting a second user interface from amongst a plurality of different user interfaces based upon the login information associated with the second user;
displaying a document by the second user interface which requests authorization of the work order request.

14. The method of claim 13, the method further comprising the steps of:
authorizing the work order request by the second user;
initiating performance of the work order request following its authorization.

15. The method of claim 12, in which the step of providing a database is further comprised of the step of providing a plurality of database modules, each module containing information associated with a different type of asset; and in which the step of selecting a work order user interface is further comprised of the step of providing database access to only a work order database module.
